(19) United States
(12) Patent Application Publication
(10) Pub. No.: US 2024/0412425 A1
(43) Pub. Date: Dec. 12, 2024

(54) METHOD, APPARATUS, DEVICE AND READABLE STORAGE MEDIUM FOR GENERATING EFFECT

(71) Applicant: Beijing Zitiao Network Technology Co., Ltd., Beijing (CN)

(72) Inventors: Zehua Bao, Beijing (CN); Xiaofeng Li, Beijing (CN)

(21) Appl. No.: 18/737,316

(22) Filed: Jun. 7, 2024

(30) Foreign Application Priority Data
Jun. 9, 2023 (CN) 202310687140.X

(51) Int. Cl. G06T 11/00; G06F 3/0482; G06F 3/16; G06T 7/40

(52) U.S. Cl. CPC G06T 11/001; G06F 3/0482; G06F 3/165; G06T 7/40; G06T 2200/24

(57) ABSTRACT

The disclosure relates to the field of image processing technologies and discloses a method, an apparatus, a device and a readable storage medium for generating an effect. The method includes: displaying a user interactive interface, the user interactive interface comprising a display control, and the display control being configured to display prompt information for triggering an effect; acquiring, in response to an effect triggering operation generated for the prompt information, characteristic information corresponding to the effect triggering operation; determining a matched texture resource collection based on the characteristic information, and determining a corresponding target texture from the texture resource collection; and rendering a corresponding target effect on the user interactive interface based on the target texture, and mounting the target effect to a designated part region of a target object.

### CROSS-REFERENCE

The present application claims priority to Chinese Patent Application No. 202310687140.X, filed on Jun. 9, 2023 and entitled “METHOD, APPARATUS, DEVICE AND READABLE STORAGE MEDIUM FOR GENERATING EFFECT”, the entirety of which is incorporated herein by reference.

### FIELD

The disclosure relates to the field of image rendering technologies, in particular to a method, an apparatus, a device and a readable storage medium for generating effect.

### BACKGROUND

Programmed texture generation usually relies on texture synthesis software, which generates rich materials by adding or adjusting features on an input image in the form of a node graph. In the related art, when the materials generated with the programmed texture are used as effect props, users need to manually select to render the effect props to designated locations, and the display effect is the same for any user, which makes it difficult to match all user types, resulting in less flexible use and display of the effect props and affecting the use experience and richness of the effect props.

### SUMMARY

In view of this, embodiments of the present disclosure provide a method, an apparatus, a device and a readable storage medium for generating effects to solve the problem of poor use experience and low richness of effect props.

In a first aspect, an embodiment of the present disclosure provides a method for generating an effect, comprising: displaying a user interactive interface, the user interactive interface comprising a display control, and the display control being configured to display prompt information for triggering an effect; acquiring, in response to an effect triggering operation generated for the prompt information, characteristic information corresponding to the effect triggering operation, the characteristic information presenting feedback information generated for the prompt information; determining a matched texture resource collection based on the characteristic information, and determining a corresponding target texture from the texture resource collection; and rendering a corresponding target effect on the user interactive interface based on the target texture, and mounting the target effect to a designated part region of a target object.

In the method for generating an effect according to the embodiment of the present disclosure, the display control for the prompt information for triggering the effect is displayed on the user interactive interface, such that the target object may perform interaction through the user interactive interface according to the prompt information to obtain the corresponding characteristic information. Accordingly, the specific target texture may be determined from the texture resource collection according to the characteristic information, then the effect may be rendered according to the target texture, and the rendered target effect may be mounted to the designated part region of the target object. Therefore, the display of the target effect may be triggered by the characteristic information corresponding to the prompt information without manual selection, which improves the use experience of the effect. Moreover, for different target objects, the characteristic information obtained according to the prompt information is different, such that the determined target textures are different, and the rendered target effects are different. Thus, the target effects displayed in the designated part region of the target object are also different, which makes the effects generated richer and achieves the effect of diversifying the effects.

In a second aspect, an embodiment of the present disclosure provides an apparatus for generating an effect, comprising: an interface displaying module configured to display a user interactive interface, the user interactive interface comprising a display control, and the display control being configured to display prompt information for triggering an effect; a triggering module configured to acquire, in response to an effect triggering operation generated for the prompt information, characteristic information corresponding to the effect triggering operation, the characteristic information presenting feedback information generated for the prompt information; a texture determining module configured to determine a matched texture resource collection based on the characteristic information, and determine a corresponding target texture from the texture resource collection; and an effect mounting module configured to render a corresponding target effect on the user interactive interface based on the target texture, and mount the target effect to a designated part region of a target object.

In a third aspect, an embodiment of the present disclosure provides an electronic device, comprising: a memory and a processor, the memory and the processor being communicatively connected with each other, the memory storing a computer instruction, and the processor, by executing the computer instruction, performing the method for generating an effect of the first aspect or any corresponding implementation thereof.

In a fourth aspect, an embodiment of the present disclosure provides a computer-readable storage medium storing a computer instruction, which causes a computer to perform the method for generating effect of the first aspect or any corresponding implementation thereof.

computer-readable storage medium storing a computer instruction, wherein the computer instruction is intended to cause a computer to perform the effect generating method of the first aspect or any corresponding embodiment thereof.

### BRIEF DESCRIPTION OF THE DRAWINGS

For clearer descriptions of the technical solutions in the specific embodiments of the present disclosure or in the prior art, the following briefly introduces the accompanying drawings required for describing the specific embodiments or the prior art. Obviously, the accompanying drawings in the following descriptions show some embodiments of the present disclosure, and a person of ordinary skill in the art may still derive other drawings from these accompanying drawings without creative efforts.

FIG. 1 is a flowchart of a method for generating an effect according to an embodiment of the present disclosure;

FIG. 2 is a schematic diagram of a user interactive interface according to an embodiment of the present disclosure;

FIG. 3 is another flowchart of the method for generating an effect according to an embodiment of the present disclosure;

FIG. 4 is yet another flowchart of the method for generating an effect according to an embodiment of the present disclosure;

FIG. 5 is another schematic diagram of the user interactive interface according to an embodiment of the present disclosure;

FIG. 6 is a flowchart of a method for generating a texture resource collection according to an embodiment of the present disclosure;

FIG. 7 is a schematic diagram of generation of a texture tile map set according to an embodiment of the present disclosure;

FIG. 8 is another flowchart of the method for generating a texture resource collection according to an embodiment of the present disclosure;

FIG. 9 is a schematic diagram of encoding of a feature map according to an embodiment of the present disclosure;

FIG. 10 is a schematic diagram of an encoded map according to an embodiment of the present disclosure;

FIG. 11 is a schematic diagram of a target texture image according to an embodiment of the present disclosure;

FIG. 12 is a schematic diagram of a geometric texture of a fabric according to an embodiment of the present disclosure;

FIG. 13 is a structural block diagram of an apparatus for generating an effect according to an embodiment of the present disclosure; and

FIG. 14 is a schematic structural diagram of hardware of an electronic device according to an embodiment of the present disclosure.

### DETAILED DESCRIPTION

In order to make the objectives, technical solutions and advantages of embodiments of the present disclosure clearer, the technical solutions of the embodiments of the present disclosure will be described clearly and completely below in combination with the accompanying drawings in the embodiments of the present disclosure. It is obvious that the described embodiments are only some of the embodiments of the present disclosure, not all embodiments of the present disclosure. All other embodiments obtained by a person of ordinary skill in the art without creative efforts based on the embodiments in the present disclosure shall fall within the protection scope of the present disclosure.

In the related art, when a material generated with programmed texture is applied as an effect, a user needs to manually select to render the effect to a designated location, and the display effect is the same for any user, which makes it difficult to match all user types, resulting in less flexible use and display of the specific effect and affecting the use experience and richness of the effect. Moreover, the effect for short videos is typically limited by the packet size which is generally below 10 MB, and it is difficult to build in rich resources in such a small space.

Based on this, in the present technical solution, prompt information is displayed to determine corresponding characteristic information, and different characteristic information is then combined to trigger the display of a different effects, which improves the use experience and richness of the effect. Meanwhile, a target texture loaded by an electronic device is issued by a cloud server, such that the limit to the packet volume of the effect can be broken through, making it convenient to request for rich texture resources from the cloud server during the operation process of the effect.

According to the embodiments of the present disclosure, an embodiment of a method for generating effect is provided. It should be noted that the steps illustrated in the flowchart of the accompanying drawings may be performed in a computer system of a set of computer-executable instructions, and that, although a logical order is illustrated in the flowchart, the steps illustrated or described may be performed in a different order in some instances than those shown herein.

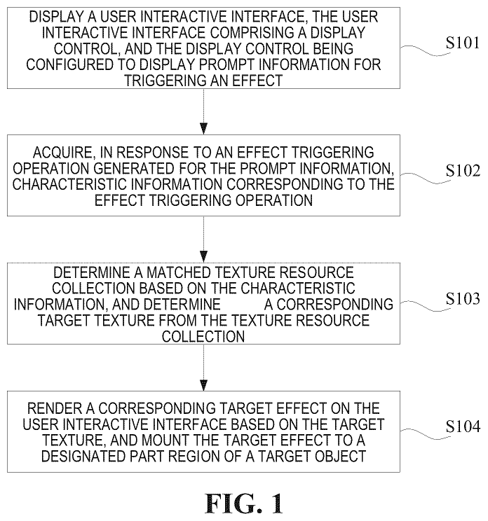

This embodiment provides a method for generating an effect, which may be applied to the aforesaid electronic device such as a mobile phone, a tablet computer, and the like. FIG. 1 is a flowchart of the method for generating an effect according to an embodiment of the present disclosure. As shown in FIG. 1, the process includes the following steps.

Step S101: displaying a user interactive interface, the user interactive interface comprising a display control, and the display control being configured to display prompt information for triggering an effect.

The user interactive interface is provided by an application program installed in an electronic device. When a user triggers a video recording function or a shooting function of the application program, a camera of the electronic device is triggered. At this point, a video recording interface or shooting interface of the application, on which a target object is displayed, is displayed on a screen of the electronic device. The video recording interface or shooting interface is the user interactive interface.

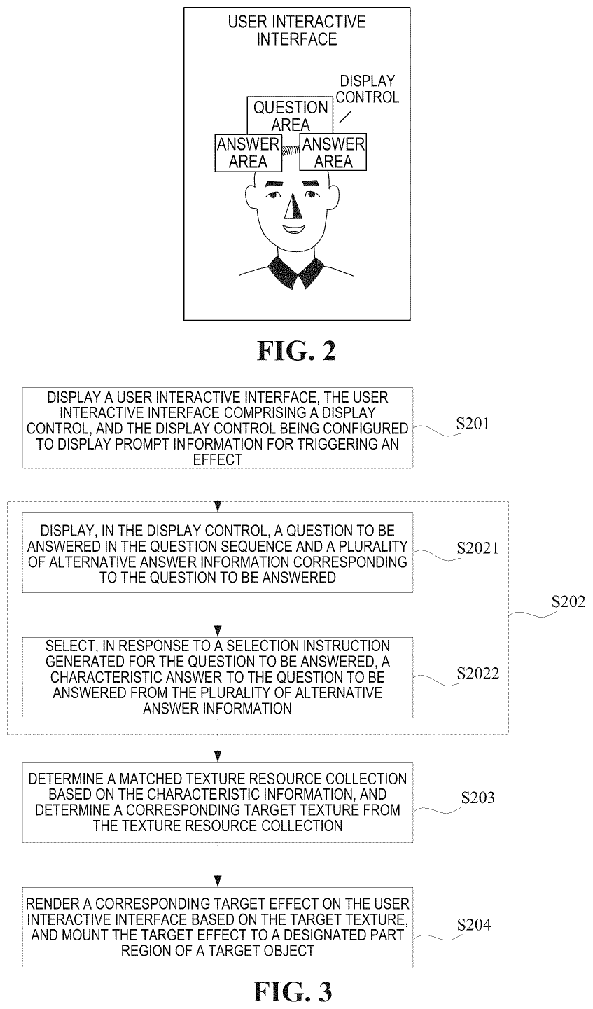

The display control is a control displayed on the user interactive interface for manual interaction, and it may be displayed at any position on the user interactive interface as long as manual interaction can be achieved. As shown in FIG. 2, a target object is displayed on the user interactive interface, and the display control may be displayed in a region above the head of the target object.

The prompt information is text information, picture information, symbol information, and the like displayed on the display control. The prompt information is composed of predetermined content which represent characteristics of the target object. Specifically, the prompt information may be saved in a predetermined file format (e.g., json) to facilitate mapping of the prompt information onto the display control.

Step S102: acquiring, in response to an effect triggering operation generated for the prompt information, characteristic information corresponding to the effect triggering operation.

The characteristic information is used to represent feedback information generated for the prompt information.

The effect triggering operation is an operation generated by the target object for the prompt information displayed in the display control. Specifically, the effect triggering operation may be a body action (e.g., shaking the head from side to side, a hand gesture, etc.), and may also be a voice response. Without doubt, there may be other triggering methods, which is not limited herein.

The characteristic information represents the feedback information generated by the target object for the prompt information, and the characteristic information generated by different target objects for the prompt information is different. Specifically, different target objects are interested in different contents. Thus, when different target objects view the prompt information, the effect triggering operation generated for the prompt information may also be different.

Taking body action as an example, the body action may be captured by the camera of the electronic device, and the user may interact with the application program through the body action with respect to the prompt information displayed in the display control. Accordingly, when the user interactive interface captures a body action made by the target object, the characteristic information generated for the prompt information may be determined based on the body action made by the target object.

S103: determining a matched texture resource collection based on the characteristic information, and determining a corresponding target texture from the texture resource collection.

The texture resource collection is a collection of a great number of texture materials obtained in combination with a deep learning model. Specifically, the texture resource collection is stored in the cloud server, and each texture material is encoded using a bitmask and has corresponding encoding information. The generation of the texture resource collection will be described in detail in the following embodiments.

The target texture is a texture resource determined from the texture resource collection, and the target texture includes an effect material texture, an effect pattern texture, and the like. Different characteristic information corresponds to different textures, and after the characteristic information is acquired, the texture resource collection is accessed based on the characteristic information to determine a corresponding target texture from the texture resource collection.

Specifically, the electronic device generates a texture resource request based on the characteristic information and sends the texture resource request to the cloud server. Accordingly, the cloud server, upon receiving the texture resource request, accesses the texture resource collection, selects a target texture corresponding to the texture resource request from the texture resource collection, and issues the target texture to the electronic device. Subsequently, the electronic device loads the target texture issued by the cloud server. Thus, the limitation to the packet volume of the effect can be broken through, making it convenient to request for rich texture resources from the cloud server during the operation process of the effect.

In a specific embodiment, a scoring algorithm may be used to calculate a score corresponding to the characteristic information. Specifically, the idea of bitmask may be used here to encode the characteristic information in binary and convert the binary to a decimal value to obtain the score corresponding to the characteristic information. Then, the texture resource request is sent to the cloud server based on the calculated score. The cloud server, in turn, may issue a corresponding target texture from the texture resource collection based on the texture resource request.

Taking the prompt information being a question sequence as an example, if there are 4 questions in the question sequence, 16 types of answers may be obtained after the bitmask encoding, and the score ranging from 0 to 15 may then be used as a texture resource request to be sent to the cloud server. The cloud server may then determine a corresponding target texture from the texture resource collection based on the texture resource request.

Step S104: rendering a corresponding target effect on the user interactive interface based on the target texture, and mounting the target effect to a designated part region of a target object.

The target effect is an effect obtained by rendering according to the target texture. The target effect is rendered in combination with the target texture, and the rendered target effect is mounted to the designated part region of the target object. For example, a scarf may be mounted on the neck region of the target object, a mask may be mounted on the face region of the target object, and a hat may be mounted on the head region of the target object, and the like, which is not specifically limited here.

In some specific implementations, the target object is areal person image of the current user captured by the camera, and the target effect may be displayed in a designated part region of the real person image.

In some specific implementations, the target object may also be a virtual character image (such as anime image, sketch image, etc.) simulated according to the user's real image, and the target effect may be displayed in a designated part region of the virtual character image.

In some specific implementations, the target object may also be a pet, a doll, and the like, and the target effect may be displayed in a designated part region of the pet, the doll, and the like.

In the method for generating an effect according to this embodiment, the display control for the prompt information for triggering the effect is displayed on the user interactive interface, such that the target object may perform interaction through the user interactive interface according to the prompt information to obtain the corresponding characteristic information. Accordingly, the specific target texture may be determined from the texture resource collection according to the characteristic information, then the effect may be rendered according to the target texture, and the rendered target effect may be mounted to the designated part region of the target object. Therefore, the display of the target effect may be triggered by the characteristic information corresponding to the prompt information without manual selection, which improves the use experience of the effect. Moreover, for different target objects, the characteristic information obtained according to the prompt information is different, such that the determined target textures are different, and the rendered target effects are different. Thus, the target effects displayed in the designated part region of the target object are also different, which makes the effects generated richer and achieves the effect of diversifying the effects.

This embodiment provides a method for generating an effect, which may be applied to the aforesaid electronic device such as a mobile phone, a tablet computer, and the like. FIG. 3 is a flowchart of the method for generating an effect according to an embodiment of the present disclosure. As shown in FIG. 3, the process includes the following steps.

Step S201: displaying a user interactive interface, the user interactive interface comprising a display control, and the display control being configured to display prompt information for triggering an effect. For a detailed description, please refer to the relevant steps in the above embodiments, which will not be repeated here.

In S202: acquiring, in response to an effect triggering operation generated for the prompt information, characteristic information corresponding to the effect triggering operation, the characteristic information representing feedback information generated for the prompt information.

Specifically, the prompt information includes a question sequence, and each question to be answered in the question sequence has corresponding answer information. Accordingly, the above step S202 may include: determining, in response to a selecting operation generated for the question sequence, a characteristic answer generated to each question in the question sequence based on the selecting operation.

The question sequence includes one or more questions presented in the display control and requiring an answer from the target object. The question sequence consists of one or more questions that are predetermined to determine the target texture. Specifically, the chatGPT technique may be employed here to assist in the design of the question sequence.

The selecting operation is an operation that the target object selects an answer for the current question to be answered. Specifically, the application program may, in response to the selecting operation of the target object for an answer, determine the characteristic answers corresponding to the respective questions to be answered.

In some optional implementations, the aforesaid step may specifically include following steps.

Step S2021: displaying, in the display control, a question to be answered in the question sequence and a plurality of alternative answer information corresponding to the question to be answered.

The plurality of alternative answer information is composed of different types of words, e.g., pairs of perceptual words that are antonyms of each other, such as, classic vs. avant-garde. The question to be answered and its corresponding alternative answer information are presented simultaneously in the display control. Specifically, as shown in FIG. 2, the display control is divided into a question area and an answer area. The question to be answered is displayed in the question area, alternative answer information is displayed in the answer area, and different alternative answer information is displayed at different locations in the answer area.

Step S2022: selecting, in response to a selection instruction generated for the question to be answered, a characteristic answer to the question to be answered from the plurality of alternative answer information.

The user triggers the display control with the selection instruction, to select answer information for the question to be answered from the answer area of the display control. The selection instruction may be a body action instruction or a voice instruction, which is not specifically limited here.

Taking a body action instruction as an example, the display control is able to respond to the body action instruction generated by the target object for the question to be answered, and thereby determine a characteristic answer selected by the target object from the plurality of alternative answer information based on the body action instruction.

Taking those illustrated in FIG. 2 as an example, when the question displayed in the question area of the display control is “Prefer black-white or color?”, the answer area shows alternative answers “Black-white” and “Color”. The target object may select “Black-white” or “Color” by a headshake action. Accordingly, the target object may determine, in response to the headshake action of the target object, the answer to the current question to be answered.

When the question displayed in the question area of the display control is “Prefer to maintain the status quo or receive a change?”, the answer area displays the alternative answers “Maintain status quo” and “Receive a change”. The target object may select “Maintain status quo” or “Receive a change” with a hand gesture action. Accordingly, the display control in the application program may determine, in response to the hand gesture action of the target object, the answer to the current question to be answered.

When the question displayed in the question area of the display control is “Prefer avant-garde or classic”, the answer area displays the alternative answers “Avant-garde” and “Classic”. The target object may answer “Avant-garde” or “Classic” by voice. Accordingly, the display control in the application program may then determine, in response to the voice instruction of the target object, the answer to the current question to be answered.

In some optional implementations, the aforesaid method may further include: displaying in the display control, in order of questions corresponding to the question sequence, a next question to be answered in response to a characteristic answer to a current question to be answered being acquired.

A plurality of questions to be answered may be presented sequentially in the display control, each question to be answered is presented in a predetermined order, and the target object may respond sequentially to each question to be answered. The plurality of questions to be answered as presented in the display control are randomly selected from a question library.

Specifically, when the question to be answered is presented in the display control, the target object may select a characteristic answer in his/her interest from the plurality of alternative answers by means of a body action. Meanwhile, the display control may trigger the display of a next question to be answered and display the next question to be answered in the question area of the display control.

Therefore, the method allows for sequentially displaying each of the questions to be answered in the display control, enabling the acquisition of the corresponding characteristic answer and facilitating the determination of a target texture that matches the current user by the characteristic answer.

In some optional implementations, the aforesaid method may further include:
step (1): determining, from the question sequence, a next question to be answered associated with a current characteristic answer in response to a characteristic answer to a current question to be answered being acquired.
step (2): displaying the next question to be answered in the display control.
step (3): hiding the display control in the user interactive interface in response to characteristic answers corresponding to individual questions to be answered in the question sequence being acquired.

The number of questions to be answered as presented in the display control is predetermined as for example 3, 4, 5, etc., and the number of questions to be answered is not specifically limited here.

The display control may sequentially display a plurality of questions to be answered, and the user may answer in turn each question to be answered. During the process of answering, whenever the target object selects a characteristic answer, the next question to be answered may be triggered, and the question to be answered is associated with the characteristic answer selected by the target object. For example, the question sequence includes four questions to be answered, when the answer selected by the target object for the second question to be answered is A1, the displayed next question to be answered is B1; and when the answer selected by the target object for the second question to be answered is A2, the displayed next question to be answered is B2.

Therefore, the various questions to be answered are associated by means of the selected answers, which make it easy to combine the characteristic answers to determine the target texture suitable for the style of the current target object, and ensures that the subsequent effect as rendered may fit the style of the target object.

When a corresponding characteristic answer has been acquired for each question to be answered as presented in the display control, the user interactive interface at this point hides the display control and triggers the loading of the target texture to mount the corresponding target effect on the designated part region of the user image.

In some optional implementations, when the user is not interested in the target effect as presented currently, he/she may re-trigger the display control by instructions such as hand gesture operations, body actions, or voice operations. Accordingly, the user interactive interface may, in response to a re-trigger instruction of the user, pop up the display control in the user interactive interface and display in the display control the current question to be answered, and the current question to be answered is not exactly the same as the last question to be answered. As a result, the display control may reacquire the characteristic answer to enable the electronic device to reload the corresponding target texture based on the characteristic answer to generate a new target effect.

In the above implementations, after the user has answered all the questions to be answered, the display control is hidden and the target texture is loaded at the same time, such that the corresponding target texture may be selected from the texture resource collection for rendering, thereby improving the immediacy and authenticity of rendering for the target effect.

Step S203: determining a matched texture resource collection based on the characteristic information, and determining a corresponding target texture from the texture resource collection. For a detailed description, please refer to the relevant steps in the above embodiments, which will not be repeated here.

Step S204: rendering a corresponding target effect on the user interactive interface based on the target texture, and mounting the target effect to a designated part region of a target object. For a detailed description, please refer to the relevant steps in the above embodiments, which will not be repeated here.

In the method for generating an effect according to this embodiment, a plurality of alternative answers corresponding to the question to be answered are displayed in the display control. Thus, a user may select a characteristic answer corresponding to the question to be answered from the alternative answers by means of a selecting operation, which facilitates loading of a corresponding target texture according to the characteristic answer of the user.

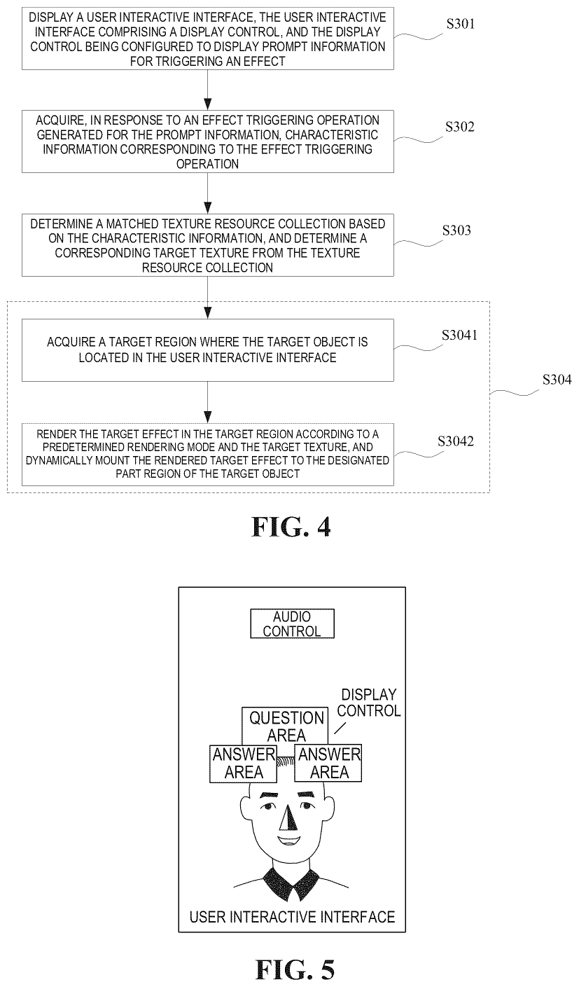

This embodiment provides a method for generating an effect, which may be applied to the aforesaid electronic device such as a mobile phone, a tablet computer, and the like. FIG. 4 is a flowchart of a method for generating an effect according to an embodiment of the present disclosure. As shown in FIG. 4, the process includes following steps.

Step S301: displaying a user interactive interface, the user interactive interface comprising a display control, and the display control being configured to display prompt information for triggering an effect. For a detailed description, please refer to the relevant steps in the above embodiments, which will not be repeated here.

Step S302: acquiring, in response to an effect triggering operation generated for the prompt information, characteristic information corresponding to the effect triggering operation, the characteristic information representing feedback information generated for the prompt information. For a detailed description, please refer to the relevant steps in the above embodiments, which will not be repeated here.

Step S303: determining a matched texture resource collection based on the characteristic information, and determining a corresponding target texture from the texture resource collection. For a detailed description, please refer to the relevant steps in the above embodiments, which will not be repeated here.

Step S304: rendering a corresponding target effect on the user interactive interface based on the target texture, and mounting the target effect to a designated part region of a target object.

Specifically, the above step S304 may include the following steps.

Step S3041: acquiring a target region where the target object is located in the user interactive interface.

The target region is a display region of the target object in the user interactive interface. Specifically, the application program may invoke a camera function of the electronic device to determine the target region where the target object is located in the user interactive interface.

Step S3042: rendering the target effect in the target region according to a predetermined rendering mode and the target texture, and dynamically mounting the rendered target effect to the designated part region of the target object.

The predetermined rendering mode is a rendering mode predetermined to render the target texture as the target effect. Specifically, in the process of rendering, light estimation may be performed in conjunction with a lighting environment where the target object displayed by the user interactive interface is located, so as to present a virtual rendering effect for the target effect that is close to the real one. The target texture is rendered according to light information acquired from the light estimation, so as to acquire the target effect that conforms to the real lighting environment.

The designated part region of the target object as displayed in the user interactive interface is identified, and the target effect is dynamically mounted in the designated part region. Taking the target effect being a scarf as an example, after the scarf is acquired by rendering according to the target texture, a neck region in the target object is identified by a target detection algorithm, and the scarf is put on the neck of the target object in a dynamic wearing manner.

In some optional implementations, the aforesaid method may further include: switching, in response to a switching operation on the target effect, a style of the target effect based on the switching operation.

The target effect generated for the target texture has a variety of styles. When the user is not satisfied with the current style of the target effect, he/she may issue a switching operation by the user interactive interface to switch the target effect. Accordingly, the user interactive interface may switch the style of the target effect in response to the switching operation issued by the user.

Therefore, the method allows for switching of the style of the target effect to facilitate the user to select the style of the effect that he/she is satisfied with, which improves the presentation effect of the target effect.

Specifically, switching the style of the target effect based on the switching operation comprises: switching, in response to a body switching action for the target effect, the target effect in order and/or in reversed order according to the body switching action.

The body switching action is a body action made by the user, such as shaking the head to the left, shaking the head to the right, waving the hand to the left, waving the hand to the right, etc., which is not specifically limited here.

In some specific implementations, a plurality of different styles of the target effect as rendered for the target texture may be presented in a preset order. If shaking the head to the left indicates switching in order and shaking the head to the right indicates switching in reversed order, when the user is not satisfied with the current style of the target effect, he/she may shake the head to the left or to the right to switch the target effect.

The aforesaid switching operation is not limited to body action, but may also be voice switching. In some specific implementations, a plurality of different styles of the target effect as rendered for the target texture may be presented in a predetermined order. If the words “next” or “switch” are uttered by voice, the target effect may be switched sequentially in the predetermined order.

As a result, different styles of effects can be acquired by rendering the target texture, and the flexible switching of effects is also allowed according to the body switching movement issued by the target object, without the need to manually operate the user interactive interface, which improves the versatility of the effects, and enriches the target object's experience for different effects.

In some optional implementations, the user interactive interface includes an audio control, and accordingly, the aforesaid method may further include: playing a target audio in response to a triggering operation on the audio control while mounting the target effect in the designated part region of the target object.

The audio control is used to trigger audio playback, and as shown in FIG. 5, the audio control is presented in the user interactive interface. The user may trigger the audio control to acquire a plurality of audio information to be selected, and then determine a target audio therefrom by previewing each piece of the audio information to be selected.

Accordingly, the audio control may enter an audio display interface in response to a triggering operation issued by the user, display, on the audio display interface, a plurality of audio information to be selected, and determine the target audio selected by the user in response to a selecting operation of the user with respect to the audio information to be selected.

As a result, the corresponding target audio can be played while the effect is generated, such that the effect is matched with the target audio, which makes the effect more vivid and improves the generation quality of the effect.

In some optional implementations, the target texture includes a pattern texture, and accordingly, the aforesaid method may further include:
step (1): determining, in response to a replacing operation on the pattern texture, a target pattern texture of the target effect based on the replacing operation.
step (2): re-rendering according to the target pattern texture to generate the target effect with a target pattern in the designated part region; and

When the user is not satisfied with the pattern texture of the target effect after several switching, he/she may select the pattern he/she is interested in from a local gallery of the electronic device as the target pattern texture. The target pattern texture is fused with the material texture corresponding to the target texture to obtain a new texture. The effect is re-rendered according to the new texture to acquire a target effect with the target pattern, and the target effect is mounted to the designated part region of the target object.

In some specific implementations, when the effect needs to be generated in an additional designated part region of the target object, the user may trigger the generation of the effect for the additional designated part region of the target object via the user interactive interface, so as to generate the effect with the same target texture in the additional designated part of the target object.

For example, if a scarf of a swallow gird style has been mounted to the neck of the target object, the generation of an effect for a face region may be triggered to dynamically generate a mask of the swallow gird style. Obviously, hats, ear protectors, glasses, etc. of the swallow gird style may also be generated.

In some specific implementations, when the user needs the generation of an effect in an additional designated part region of the user image, her/she may trigger the generation of an effect for the additional designated part region of the target object via the user interactive interface. At this point, the user interactive interface may pop up the display control again, and the user may answer the question on the display control through body movements. Accordingly, after the display control acquires a characteristic answer to the question to be answered, a target texture corresponding to the characteristic answer is acquired, and the corresponding effect is mounted to the additional designated part region.

For example, if a striped scarf has been mounted to the neck of the target object, when the generation of the effect for a head region is triggered, the user interactive interface may pop up the display control again, and the target object may answer via the body movement the question to be answered as presented on the display control. After acquiring a characteristic answer to the question to be answered, the display control may again acquire the target texture corresponding to the characteristic answer. Assuming that the newly acquired target texture is a swallow gird texture, the hat with the swallow gird texture may be dynamically mounted in the head region.

Therefore, the method allows the user to re-select the target pattern texture when the current target effect does not meet the user's needs, such that the effect can be re-rendered according to the target pattern texture, thereby further enriching the pattern material of the effect and improving the user experience of the effect.

The method for generating an effect according to this embodiment allows for mounting a target effect to a designated part region of a target object dynamically so as to present the target effect in the designated part region, thereby achieving the dynamic wearing of the target effect and increasing the authenticity and interestingness of the mounting of the effect.

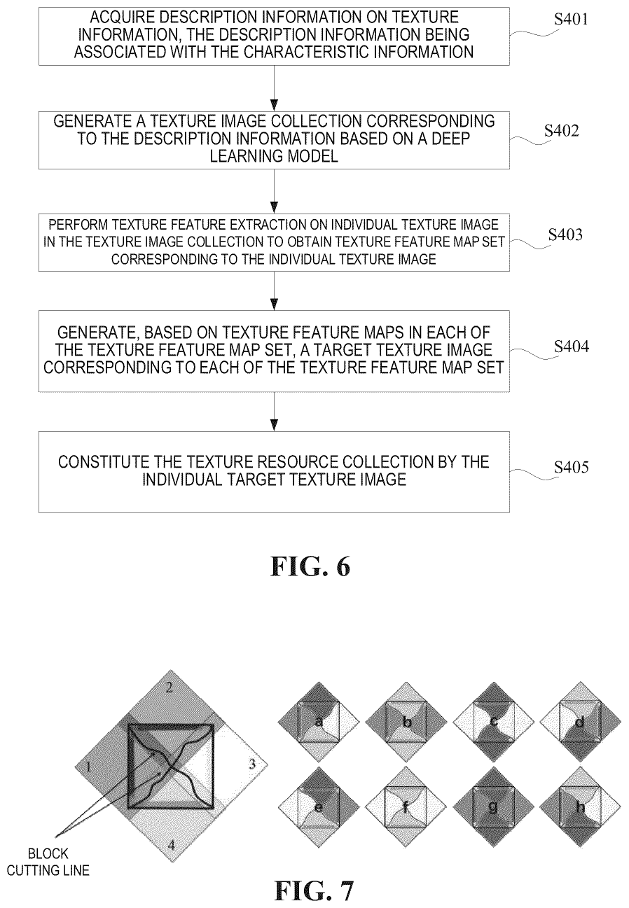

In this embodiment, a method for generating a texture resource collection is provided, applicable to devices, for example, a cloud server. The texture resource collection used in the above embodiment is generated by the following methods. As shown in FIG. 6, the process of generating the texture resource collection includes the following steps.

Step S401: acquiring description information on texture information, the description information being associated with the characteristic information.

The description information represents texture features, and the description information is input to the cloud server according to actual needs. In addition, the description information is associated with the characteristic information, such that a desired target texture can be subsequently determined in conjunction with the association relationship. Specifically, a technician may input a series of description information about the desired texture information into the cloud server. Correspondingly, the cloud server may acquire the description information about the texture information input by the technician.

Step S402: generating a texture image collection corresponding to the description information based on a deep learning model.

The deep learning model, for example, a machine learning model that generates content based on artificial intelligence, is deployed in the cloud server. The cloud server may input the acquired description information on the texture information into the deep learning model, and output a large volume of texture picture materials by means of the deep learning model. The large volume of texture picture materials constitute the texture image collection.

Step S403: performing texture feature extraction on individual texture image in the texture image collection to obtain texture feature map set corresponding to the individual texture image.

In a specific embodiment, each texture image in the texture image collection is pre-processed by means of a texture synthesis algorithm, so as to process a non-quadrilateral continuous texture image into a quadrilateral continuous texture image. That is, the same texture image has an upper edge and a lower edge in seamless connection, and a left edge and a right edge in seamless connection.

Taking four basic blocks (1, 2, 3 and 4 in FIG. 7) as an example, firstly, a minimum error path of overlapping portions of the adjacent blocks is calculated in sequence; secondly, each block is cut along a diagonal to form four new edges, and a region surrounded by the four edges is a basic texture tile; and thirdly, the desired texture tile map set is composed in the same way, and then texture generation rules may be applied for the programmed texture generation.

A pre-processed texture image with a resolution of M*M is selected for texture sampling to extract texture features from the texture image. 16 texture feature maps with a resolution of N*N may be obtained according to the extracted texture features. The 16 texture feature maps constitute the texture feature map set.

After test, it is found that a texture image with more high-frequency signals has a better texture effect, while a texture image containing too much lighting information has a poor texture effect. The texture image containing less lighting information is preferred when texture sampling is performed. The resolution may be selected according to actual needs, which is not specifically limited here.

Step S404: generating, based on texture feature maps in each of the texture feature map set, a target texture image corresponding to each of the texture feature map set.

Step S405: constituting the texture resource collection by the individual target texture image.

The texture feature maps contained in each texture feature map set are spliced to generate the target texture image corresponding to each texture feature map set. The target texture images corresponding to each texture feature map set are combined to build the corresponding texture resource collection.

Starting from an upper edge line of the texture feature map, each edge of each texture feature map in the texture feature map set is assigned a corresponding attribute eigenvalue, for example, N, E, S and W represent an upper edge, a right edge, a lower edge and a left edge respectively. Two edges having the same attribute eigenvalue may be in seamless connection, such that the texture feature maps in the texture feature map set may be joined according to the attribute eigenvalue to generate a quadrilateral continuous target texture image.

Different texture feature map sets correspond to different target texture images, and by virtue of image processing software, fusion calculation is performed on the individual target texture images and various types of fabric textures to generate texture maps required by a PBR material. Meanwhile, a model of the effect is generated by using 3 D design software. The model is bound with a human body 3 D skeleton, dynamics is applied to the model, and textures are prefabricated with the texture feature map, so as to obtain various types of target texture images to form the texture resource collection. Furthermore, the textures in different types of texture resource collections are encoded to facilitate matching with the characteristic information.

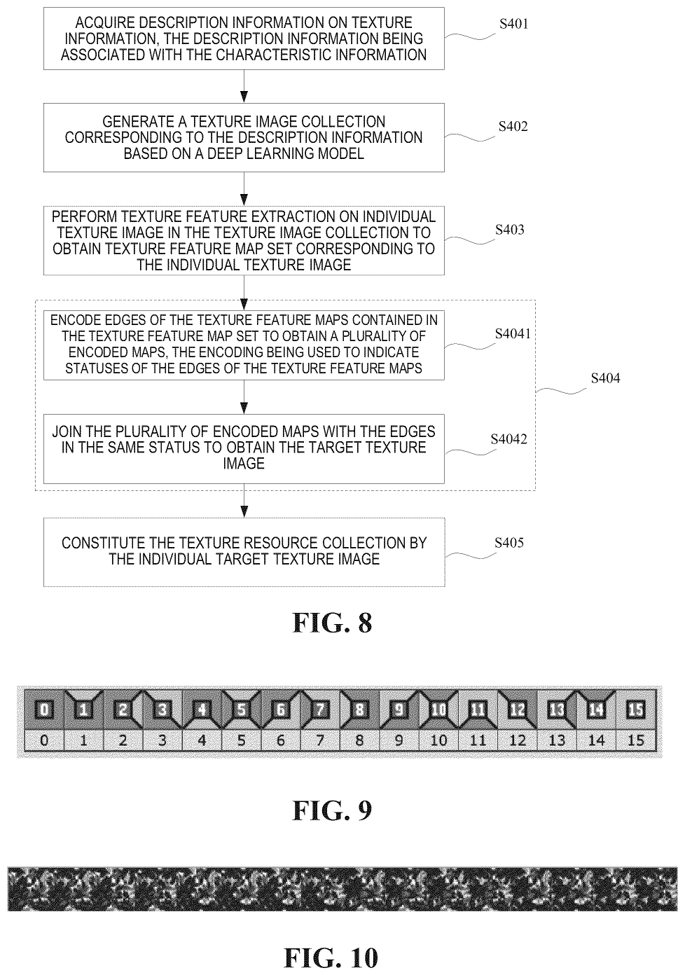

Specifically, as shown in FIG. 8, step S404 may include the following steps.

Step S4041: encoding edges of the texture feature maps contained in the texture feature map set to obtain a plurality of encoded maps, the encoding being used to indicate statuses of the edges of the texture feature maps.

The number of elements in the texture feature map set is determined by the attributes of the edges, and a group of encoded maps are obtained by performing encoding according to the possible attributes of each edge. Taking a rectangular texture feature map as an example, there are 16 statuses of the edge if each edge has two possible attributes (color and shape).

As shown in FIG. 9, each texture feature map is assigned an index value. Assuming that the four edges of the rectangular texture feature map each have only two possibilities: 0 (not available) and 1 (available), the status 1 of the “upper edge” may be defined as a value 1, the status 1 of the “right edge” may be defined as a value 2, the status 1 of the “lower edge” may be defined as a value 4 and the status 1 of the “left edge” may be defined as a value 8. Thus, the statuses of all the edges of the texture feature map may be represented.

Step S4042: joining the plurality of encoded maps with the edges in the same status to obtain the target texture image.

For two encoded maps to be spliced, their statuses of edges need to be the same, and a seamless target texture image may be obtained by splicing the two encoded maps together. For example, as shown in FIG. 9, two encoded maps may only be spliced if the corresponding colors are the same. The upper edge of the encoded map numbered 1 is yellow, so if another encoded map is to be spliced on top of it, the new encoded map only needs to meet the condition that the lower edge is yellow, and 4, 5, 6, 7, 12, 13, 14 and 15 all meet the condition.

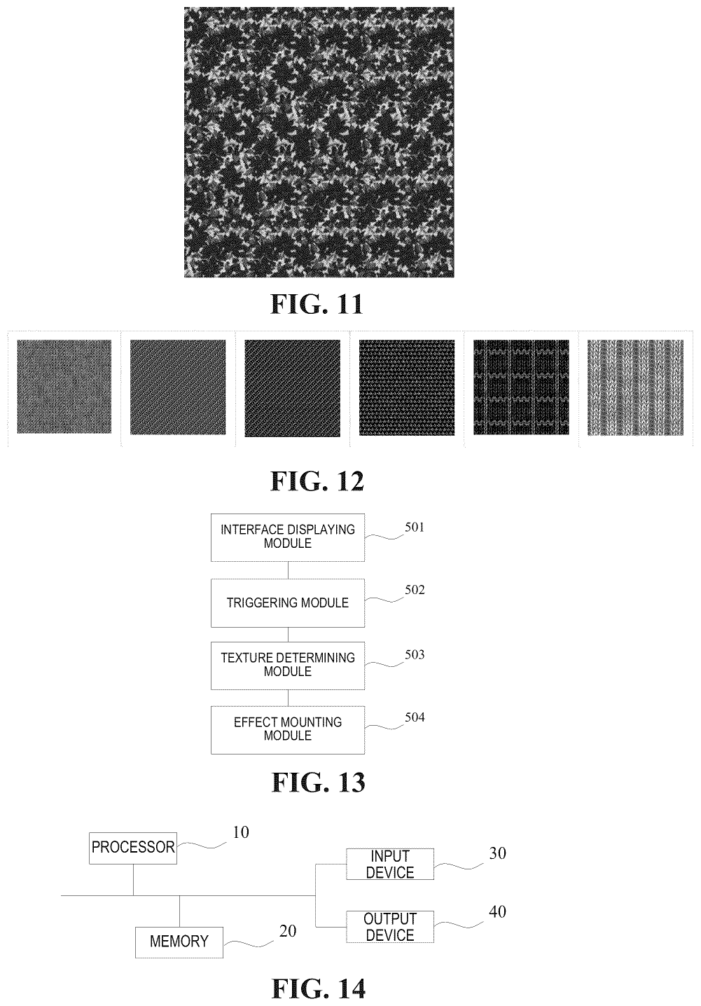

Further, the encoded map (as shown in FIG. 10) is decoded to obtain a seamless target texture image (as shown in FIG. 11). Then, fusion calculation is performed on the seamless target texture image and various types of fabric geometric textures (as shown in FIG. 12) to generate the texture map required by the PBR material.

By encoding the texture feature maps in the texture feature map set, the encoded maps obtained after encoding are re-spliced according to the same status of the edges to obtain the target texture image, which ensures the consistency in splicing the target texture image, eliminating splicing traces of the target texture image and improving the generation quality of the target texture image.

In the method for generating an effect according to this embodiment, the acquired description information on the texture information is used to generate the texture image collection based on the deep learning model, facilitating generation of a large volume of texture image materials. Texture feature extraction is performed on the texture image materials, and the texture feature map set is acquired using the texture features for programmed generation to obtain the texture resource collection. Therefore, by combining the deep learning model and the programmed texture generation, a large volume of high-quality materials can be obtained, which improves the material richness of the texture resource collection and the material generation efficiency, facilitates the provision of a large number of texture materials for the effect, and makes the effects generated more diversified.

An embodiment further provides an apparatus for generating an effect for implementing the aforesaid embodiments and preferred embodiments, which have already been described and thus will not be repeated here. As used hereinafter, the term “module” may be a combination of software and/or hardware that implements a predetermined function. Although the apparatus described in the following embodiments is preferably implemented in software, the implementation in hardware or in a combination of software and hardware is also possible and can be contemplated.

The embodiment provides the apparatus for generating an effect, as shown in FIG. 13, including:

an interface displaying module 501 configured to display a user interactive interface, the user interactive interface comprising a display control, and the display control being configured to display prompt information for triggering an effect;

a triggering module 502 configured to acquire, in response to an effect triggering operation generated for the prompt information, characteristic information corresponding to the effect triggering operation, the characteristic information representing feedback information generated for the prompt information;

a texture determining module 503 configured to determine a matched texture resource collection based on the characteristic information, and determine a corresponding target texture from the texture resource collection; and

an effect mounting module 504 configured to render a corresponding target effect on the user interactive interface based on the target texture, and mount the target effect to a designated part region of a target object.

In some optional embodiments, the prompt information includes a question sequence, and the triggering module 502 may include:

a selecting unit configured to determine, in response to a selecting operation generated for the question sequence, a characteristic answer generated to each question in the question sequence, based on the selecting operation.

In some optional embodiments, the selecting unit includes:
a question and answer displaying sub-unit configured to display, in the display control, a question to be answered in the question sequence and a plurality of alternative answer information corresponding to the question to be answered; and
an answer determining sub-unit configured to select, in response to a selection instruction generated for the question to be answered, a characteristic answer to the question to be answered from the plurality of alternative answer information.

In some optional embodiments, the triggering module 502 may further include:
a sequential displaying unit configured to display in the display control, in order of questions corresponding to the question sequence, a next question to be answered in response to a characteristic answer to a current question to be answered being acquired.

In some optional embodiments, the triggering module 502 may further include:
an associating unit configured to determine, from the question sequence, a next question to be answered associated with a current characteristic answer in response to a characteristic answer to a current question to be answered being acquired;
a next-question displaying unit configured to display the next question to be answered in the display control; and
a hiding unit configured to hide the display control in the user interactive interface in response to characteristic answers corresponding to individual questions to be answered in the question sequence being acquired.

In some optional embodiments, the effect mounting module 504 may include:
a region acquiring unit configured to acquire a target region where the target object is located in the user interactive interface; and
a mounting unit configured to render the target effect in the target region according to a predetermined rendering mode and the target texture, and dynamically mount the rendered target effect to a designated part region of the target object.

In some optional embodiments, the apparatus may further include:
a switching module configured to switch, in response to a switching operation on the target effect, a style of the target effect based on the switching operation.

In some optional embodiments, the switching module described above may be specifically configured to: switch, in response to a body switching movement for the target effect, the target effect in order and/or in reversed order according to the body switching action.

In some optional embodiments, the user interactive interface includes an audio control, and correspondingly, the apparatus may further include:
an audio triggering module configured to play a target audio in response to a triggering operation on the audio control while mounting the target effect to the designated part region of the target object.

In some optional embodiments, the apparatus may further include:
a pattern selecting module configured to determine, in response to a replacing operation on the pattern texture, a target pattern texture of the target effect based on the replacing operation; and
a rendering module configured to perform re-rendering according to the target pattern texture to generate the target effect with a target pattern in the designated part region.

In some optional embodiments, the apparatus may further include:
a texture generating module configured to generate a texture resource collection.

Specifically, the texture generating module may include:
a description information acquiring unit configured to acquire description information on texture information, wherein the description information is associated with characteristic information;
a first generating unit configured to generate a texture image collection corresponding to the description information based on a deep learning model;
a feature extracting unit configured to perform texture feature extraction on individual texture image in the texture image collection to obtain texture feature map sets corresponding to the individual texture image;
a second generating unit configured to generate, based on a texture feature map in each of the texture feature map set, a target texture image corresponding to each of the texture feature map set; and
a collection generating unit configured to constitute the texture resource collection by the individual target texture images.

In some optional embodiments, the second generating unit may include:
an encoding sub-unit configured to encode edges of the texture feature maps contained in the texture feature map set to obtain a plurality of encoded maps, wherein the encoding is used to indicate the statuses of the edges of the texture feature maps; and
a map joining sub-unit configured to join the plurality of encoded maps with the edges in the same status to obtain the target texture image.

Further functional descriptions of the above-mentioned modules and units are the same as those of the above-mentioned corresponding embodiments, and thus will not be repeated here.

The effect generating apparatus in this embodiment is presented in the form of a functional unit, the unit here refers to an ASIC, a processor and a memory that execute one or more software or fixed programs, and/or other devices that can provide the above functions.

In the effect generating apparatus according to the embodiment, the presentation of the target effect may be triggered by the characteristic information corresponding to the prompt information without manual selection, which improves the user experience of the effect. Moreover, for different target objects, the characteristic information obtained according to the prompt information is different, such that the determined target textures are different, and the rendered target effects are different. Thus, the target effects presented in the designated part region of the target object are also different, which makes the effects generated richer and achieves the effect of diversifying the effects.

An embodiment of the present disclosure further provides an electronic device, which is provided with the effect generating apparatus shown in FIG. 13 above.

Please refer to FIG. 14, which is a schematic structural diagram of an electronic device according to an optional embodiment of the present disclosure. As shown in FIG. 14, the electronic device includes at least one processor 10, a memory 20, and interfaces for connecting various components, including a high-speed interface and a low-speed interface. The components are in communication connection with each other by using different buses, and may be installed on a common motherboard or in other ways as needed. The processor may process an instruction executed within a computer device, including an instruction stored in or on the memory to display graphical information of a GUI on an external input/output device (for example, a display device coupled to the interface). In some optional embodiments, a plurality of processors and/or a plurality of buses may be used with a plurality of memories, if necessary. Similarly, a plurality of computer devices may be connected, and each device provides some of necessary operations (for example, as a server array, a group of blade servers, or a multiprocessor system). One processor 10 is taken as an example in FIG. 14.

The processor 10 may be a central processing unit, a network processor or a combination thereof. The processor 10 may further include a hardware chip. The hardware chip may be an application specific integrated circuit, a programmable logic device or a combination thereof. The programmable logic device may be a complex programmable logic device, a field programmable logic gate array, a generic array logic or any combination thereof.

The memory 20 stores an instruction executable by at least one processor 10, such that the at least one processor 10 may perform the method shown in the foregoing embodiment.

The memory 20 may include a program storage area and a data storage area, wherein the program storage area may store applications required by an operating system and at least one function, and the data storage area may store data created by the use of a computer device according to presentation of a small program landing page, etc. Furthermore, the memory 20 may include a high-speed random-access memory, and may further include a non-transient memory, for example, at least one disk memory device, a flash memory device, or other non-transient solid-state memory devices. In some optional embodiments, the memory 20 optionally includes memories provided remotely relative to the processor 10, and the remote memories may be connected to the computer device over a network. Examples of the above networks include, but are not limited to, the Internet, the intranet, a local area network, a mobile communication network and their combinations.

The memory 20 may include a volatile memory, for example, a random-access memory; the memory may also include a non-volatile memory, for example, a flash memory, a hard disk or a solid-state hard disk; and the memory 604 may also include a combination of the above memories.

The computer device further includes an input device 30 and an output device 40. The processor 10, the memory 20, the input device 30 and the output device 40 may be connected via a bus or by other means, and are connected via a bus in FIG. 14 as an example.

The input device 30 may receive input digital or character information and generate key signal inputs related to user settings and function controls of the computer device, and include, for example, a touch screen, a keypad, a mouse, a track pad, a touch pad, an indicator stem, at least one mouse button, a trackball, a joystick and the like. The output device 40 may include a display device, an auxiliary lighting apparatus (for example, an LED), a tactile feedback apparatus (for example, a vibration motor), and the like. The display device described above includes, but is not limited to, a liquid crystal display, a light-emitting diode, a display and a plasma display. In some optional embodiments, the display device may be a touch screen.

The computer device further includes a communication interface for communication between the computer device and other devices or communication networks.

An embodiment of the present invention further provides a computer-readable storage medium, and the above-mentioned method according to the embodiment of the present invention may be implemented in hardware or firmware, or implemented as a computer code that may be recorded on a storage medium, or implemented as a computer code that is downloaded over a network and originally stored in a remote storage medium or a non-transitory machine-readable storage medium and is to be stored on a local storage medium, such that the method described here may be processed by such software stored on a storage medium using a general-purpose computer, a dedicated processor, or programmable or special-purpose hardware. The storage medium may be a magnetic disk, an optical disk, a read-only memory, a random-access memory, a flash memory, a hard disk, a solid-state hard disk, or the like. Further, the storage medium may further include a combination of the above memories. It can be understood that a computer, a processor, a microprocessor controller or programmable hardware includes a storage component capable of storing or receiving software or the computer code, and the software or the computer code, when accessed and executed by the computer, the processor or the hardware, implements the method shown in the above embodiment.

Although the embodiments of the present disclosure have been described with reference to the accompanying drawings, those skilled in the art can make various modifications and variations without departing from the spirit and scope of the present disclosure, and such modifications and variations shall all fall within the scope defined by the appended claims.

1. A method for generating an effect, comprising:
displaying a user interactive interface, the user interactive interface comprising a display control, and the display control being configured to display prompt information for triggering an effect;
acquiring, in response to an effect triggering operation generated for the prompt information, characteristic information corresponding to the effect triggering operation, the characteristic information presenting feedback information generated for the prompt information;
determining a matched texture resource collection based on the characteristic information, and determining a corresponding target texture from the texture resource collection; and
rendering a corresponding target effect on the user interactive interface based on the target texture, and mounting the target effect to a designated part region of a target object.

2. The method according to claim 1, wherein the prompt information comprises a question sequence, and acquiring, in response to the effect triggering operation generated for the prompt information, the characteristic information corresponding to the effect triggering operation comprises:
determining, in response to a selecting operation generated for the question sequence, a characteristic answer generated to each question in the question sequence based on the selecting operation.

3. The method according to claim 2, wherein determining, in response to the selecting operation generated for the question sequence, the characteristic answer generated to each question in the question sequence based on the selecting operation comprises:
displaying, in the display control, a question to be answered in the question sequence and a plurality of alternative answer information corresponding to the question to be answered; and
selecting, in response to a selection instruction generated for the question to be answered, a characteristic answer to the question to be answered from the plurality of alternative answer information.

4. The method according to claim 3, further comprising:
displaying in the display control, in order of questions corresponding to the question sequence, a next question to be answered in response to a characteristic answer to a current question to be answered being acquired.

5. The method according to claim 3, further comprising:
determining, from the question sequence, a next question to be answered associated with a current characteristic answer in response to a characteristic answer to a current question to be answered being acquired;
displaying the next question to be answered in the display control;
and/or,
hiding the display control in the user interactive interface in response to characteristic answers corresponding to individual questions to be answered in the question sequence being acquired.

6. The method according to claim 1, wherein rendering the corresponding target effect on the user interactive interface based on the target texture, and mounting the target effect to the designated part region of the target object comprise:
acquiring a target region where the target object is located in the user interactive interface; and
rendering the target effect in the target region according to a predetermined rendering mode and the target texture, and dynamically mounting the rendered target effect to the designated part region of the target object.

7. The method according to claim 6, further comprising:
switching, in response to a switching operation on the target effect, a style of the target effect based on the switching operation.

8. The method according to claim 7, wherein switching, in response to the switching operation on the target effect, the style of the target effect based on the switching operation comprises:
switching, in response to a body switching action for the target effect, the target effect in order and/or in reversed order according to the body switching action.

9. The method according to claim 6, wherein the user interactive interface comprises an audio control, and the method further comprises:
playing a target audio in response to a triggering operation on the audio control while mounting the target effect in the designated part region of the target object.

10. The method according to claim 6, wherein the target texture comprises a pattern texture, and the method further comprises: after mounting the target effect to the designated part region of the target object,
determining, in response to a replacing operation on the pattern texture, a target pattern texture of the target effect based on the replacing operation; and
re-rendering according to the target pattern texture to generate the target effect with a target pattern in the designated part region.

11. The method according to claim 1, wherein the texture resource collection is generated by:
acquiring description information on texture information, the description information being associated with the characteristic information;
generating a texture image collection corresponding to the description information based on a deep learning model;
performing texture feature extraction on individual texture image in the texture image collection to obtain texture feature map set corresponding to the individual texture image;
generating, based on texture feature maps in each of the texture feature map set, a target texture image corresponding to each of the texture feature map set; and
constituting the texture resource collection by the individual target texture image.

12. The method according to claim 11, wherein generating, based on the texture feature maps in each of the texture feature map sets, the target texture image corresponding to each of the texture feature map sets comprises:
encoding edges of the texture feature maps contained in the texture feature map set to obtain a plurality of encoded maps, the encoding being used to indicate statuses of the edges of the texture feature maps; and
joining the plurality of encoded maps with the edges in the same status to obtain the target texture image.

13. An electronic device, comprising:
a memory and a processor, the memory and the processor being communicatively connected with each other, the memory storing a computer instruction, and the processor, by executing the computer instruction, performing the acts comprising:
displaying a user interactive interface, the user interactive interface comprising a display control, and the display control being configured to display prompt information for triggering an effect;
acquiring, in response to an effect triggering operation generated for the prompt information, characteristic information corresponding to the effect triggering operation, the characteristic information presenting feedback information generated for the prompt information;
determining a matched texture resource collection based on the characteristic information, and determining a corresponding target texture from the texture resource collection; and
rendering a corresponding target effect on the user interactive interface based on the target texture, and mounting the target effect to a designated part region of a target object.

14. The electronic device according to claim 13, wherein the prompt information comprises a question sequence, and acquiring, in response to the effect triggering operation generated for the prompt information, the characteristic information corresponding to the effect triggering operation comprises:
determining, in response to a selecting operation generated for the question sequence, a characteristic answer generated to each question in the question sequence based on the selecting operation.

15. The electronic device according to claim 14, wherein determining, in response to the selecting operation generated for the question sequence, the characteristic answer generated to each question in the question sequence based on the selecting operation comprises:
displaying, in the display control, a question to be answered in the question sequence and a plurality of alternative answer information corresponding to the question to be answered; and
selecting, in response to a selection instruction generated for the question to be answered, a characteristic answer to the question to be answered from the plurality of alternative answer information.

16. The electronic device according to claim 15, the acts further comprising:
displaying in the display control, in order of questions corresponding to the question sequence, a next question to be answered in response to a characteristic answer to a current question to be answered being acquired.

17. The electronic device according to claim 15, the acts further comprising:
determining, from the question sequence, a next question to be answered associated with a current characteristic answer in response to a characteristic answer to a current question to be answered being acquired;
displaying the next question to be answered in the display control;
and/or,
hiding the display control in the user interactive interface in response to characteristic answers corresponding to individual questions to be answered in the question sequence being acquired.

18. The electronic device according to claim 13, wherein rendering the corresponding target effect on the user interactive interface based on the target texture, and mounting the target effect to the designated part region of the target object comprise:
acquiring a target region where the target object is located in the user interactive interface; and
rendering the target effect in the target region according to a predetermined rendering mode and the target texture, and dynamically mounting the rendered target effect to the designated part region of the target object.

19. The electronic device according to claim 18, the acts further comprising:
switching, in response to a switching operation on the target effect, a style of the target effect based on the switching operation.

20. A non-transitory computer-readable storage medium storing a computer instruction, which causes a computer to perform the method for generating effect comprising:
displaying a user interactive interface, the user interactive interface comprising a display control, and the display control being configured to display prompt information for triggering an effect;
acquiring, in response to an effect triggering operation generated for the prompt information, characteristic information corresponding to the effect triggering operation, the characteristic information presenting feedback information generated for the prompt information;
determining a matched texture resource collection based on the characteristic information, and determining a corresponding target texture from the texture resource collection; and
rendering a corresponding target effect on the user interactive interface based on the target texture, and mounting the target effect to a designated part region of a target object.
